(19) United States
(12) Patent Application Publication
(10) Pub. No.: US 2018/0229987 A1
(43) Pub. Date: Aug. 16, 2018

(54) Device for Transporting a Transport Item, and Method

(71) Applicant: Kaup GmbH & Co. KG, Aschaffenburg (DE)

(72) Inventor: Otmar Kaup, Aschaffenburg (DE)

(21) Appl. No.: 15/750,211

(22) PCT Filed: Aug. 4, 2016
(86) PCT No.: PCT/DE2016/000302

§ 371 Date: Feb. 5, 2018

(30) Foreign Application Priority Data
Aug. 4, 2015 (DE) 102015009844.6

(51) Int. Cl. B66F 9/14; B66F 9/12; B66F 9/18

(52) U.S. Cl. CPC B66F 9/147; B66F 9/181; B66F 9/122

(57) ABSTRACT

Apparatus for transport of a transport item for arranging at a lifting vehicle, especially at a transportation unit of a fork lifter, especially of a commissioning package, especially with a load lower than about 50 kg, comprising a means for at least temporarily picking up of the transport item by a vacuum means and/or a transportation belt, whereas the vacuum means is to be attached to the transport item essentially in the horizontal, and/or the transportation belt at a lower edge of the transport item, whereas the vacuum means and/or the transportation belt is attached to an pivot arm with a pivot point, which allows a handling of the transport item with the vacuum means and/or the transportation belt, especially a pivoting, especially in a defined pivoting angle, especially about +/−90°, in the horizontal, and/or allows dropping of the transport item, especially in the horizontal.

### CROSS REFERENCE TO RELATED APPLICATIONS

This application is the U.S. national stage of International Application No. PCT/DE2016/000302, filed on 2016 Aug. 4. The international application claims the priority of DE 102015009844.6 filed on 2015 Aug. 4; all applications are incorporated by reference herein in their entirety.

### BACKGROUND

The invention relates to an apparatus for transport of a transport item for attaching at a lifting vehicle, according to the generic term of claim 1 and a method for using of an apparatus for transport of a transport item according to the generic term if claim 10.

Commissioning tasks for storages with many side corridors are solved in the state of the art for example by pallet turning devices, the pallets are turned at a moment, at which the handling of the transport item in an advantageous body posture is possible. Unfavorable is the high load capacity and the necessity of a massive fork lifter.

### SUMMARY

Apparatus for transport of a transport item for arranging at a lifting vehicle, especially at a transportation unit of a fork lifter, especially of a commissioning package, especially with a load lower than about 50 kg, comprising a means for at least temporarily picking up of the transport item by a vacuum means and/or a transportation belt, whereas the vacuum means is to be attached to the transport item essentially in the horizontal, and/or the transportation belt at a lower edge of the transport item, whereas the vacuum means and/or the transportation belt is attached to an pivot arm with a pivot point, which allows a handling of the transport item with the vacuum means and/or the transportation belt, especially a pivoting, especially in a defined pivoting angle, especially about +/−90°, in the horizontal, and/or allows dropping of the transport item, especially in the horizontal.

### DETAILED DESCRIPTION

The problem to be solved by the present invention is to provide a simple and reliable handling of a transport item for commissioning, whereas the persons working with it are unburdened from physical activities.

The problem is solved by an apparatus for transport of a transport item for arranging at a lifting vehicle, especially at a transportation unit of a fork lifter, especially of a commissioning package, especially with a load lower than about 50 kg, comprising a means for at least temporarily picking up the transport item by a vacuum means and/or a transportation belt, whereas the vacuum means is to be attached to the transport item essentially in the horizontal, and/or the transportation belt at a lower edge of the transport item, whereas the vacuum means and/or the transportation belt is attached to an pivot arm with a pivot point, which allows a handling of the transport item with the vacuum means and/or the transportation belt, especially a pivoting, especially in a defined pivoting angle, especially about +/−90°, in the horizontal, and/or allows dropping of the transport item, especially in the horizontal

With the pivoting movement and pulling movement or rather pushing movement it is only necessary by the force of vacuum to overcome essentially just a frictional resistance. Therefor it is possible to work with a low vacuum and/or by a transporting belt on the pivot arm. Further it can be managed by the adjustable movement and pulling movement or rather pushing movement even in narrow side corridors to pick loads from shelves, turn them around and unload them for commissioning on pallets. Herewith it is especially advantageous, that large distances are avoided, which have to be managed during commissioning between sampling point and an parked pallet in the shelf corridor, what is time consuming.

It is advantageous, if the pivot arm is provided to be adjustable longitudinally with a means for pivoting, especially with an oil motor and/or a means for adjusting the length, driven especially by a hydraulic means and or means, that is driven by an oil motor.

It is advantageous, if the vacuum means is formed adjustable longitudinally in relation to the pivot arm, especially upper or lower, especially by a chain drive, which is driven specially by an oil motor.

It is advantageous, if the pivot arm with a driving means, especially in the surrounding of the pivot point, is arranged to be driven laterally, especially by a chain drive, especially driven by an oil motor, especially arranged at a transport unit of a lifting vehicle.

It is advantageous, if the vacuum means is provided adjustable with a second pivoting means for a direction down to a direction horizontal, whereas for the transport of the transport item the vacuum means is pivoted hereby into horizontal.

It is advantageous, if the vacuum means is moveable arranged on the pivot arm, so that the transport item can be picked up by the vacuum means and to be accommodated rested for at least temporary on the pivot arm and/or deposable from it.

It is advantageous, if a means for transport of a pallet is provided, whereas especially two or more forks are provided, on which the pallet is to be transported and to be loaded with the transport item and/or unloaded, especially comprising fork stubs with attachable fork shoes and or forks, that are provided with transportation blets for loading and/or unloading of pallet s.

It is advantageous, if the vacuum means is provided with vacuum by a vacuum pump, especially arranged in a section between pivot arm and driving means, whereas the vacuum pump is especially driven by a electromotor and/or oil motor, and/or by a combination means comprising a hydraulic zylinder and/or air zylinder and or preloading valve, especially driven by an oil motor, so that especially first a vacuum is gained by the hydraulic zylinder with the air zylinder and then a driving movement auf the pivot arm is executable.

It is advantageous, if the vacuum means comprises one or more vacuum cups, which are especially arranged beneath each other.

The problem is solved as well by a method for use of an apparatus for transport of a transport item, especially of a distribution package, especially with a load lower than about 50 kg, whereby the apparatus is suitable for attachment to a transport unit at a lifting vehicle, especially at a fork lifter, whereas by a means for at least temporarily picking up a transport item is picked up by a vacuum means and/or a transportation belt, whereas the vacuum means is attached to the transport item essentially in the horizontal, and/or the transportation belt is attached at a lower edge of the transport item, whereas the vacuum means and/or the transportation belt is attached to an pivot arm with a pivot point, so that the transport item is pivoted by the vacuum means and/or the transportation belt especially in the horizontal, in e defined pivoting angle, especially about +/−90°, and/or on the pivot arm by a method of the vacuum means and/or der transportation belt uploaded and unloaded.

Further features and advantages of the invention arise out of the claims and following description, where application examples of the object of the invention in combination with the figures are explained in further detail.

### BRIEF DESCRIPTION OF THE DRAWINGS

FIG. 1a apparatus for transport,

FIG. 1b apparatus for transport,

FIG. 1c apparatus for transport,

FIG. 1d apparatus for transport,

FIG. 2a apparatus for transport in side view,

FIG. 2b apparatus for transport in plan view,

FIG. 3 apparatus for transport,

FIG. 4 apparatus for transport and

FIG. 5 apparatus for transport, with fork stubs.

### DETAILED DESCRIPTION OF THE PREFERRED EMBODIMENTS

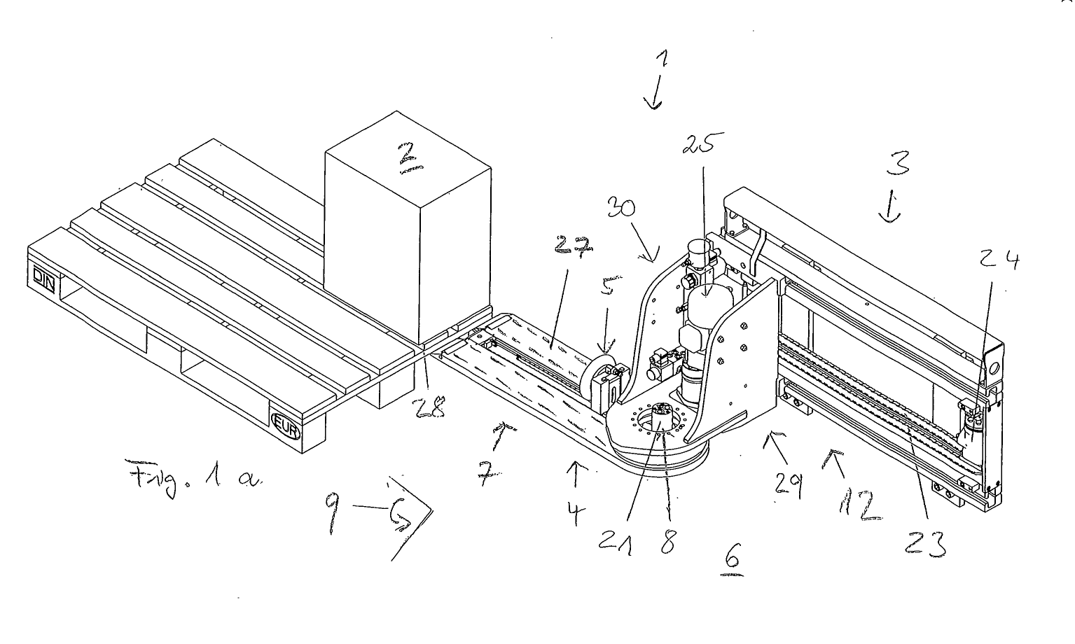

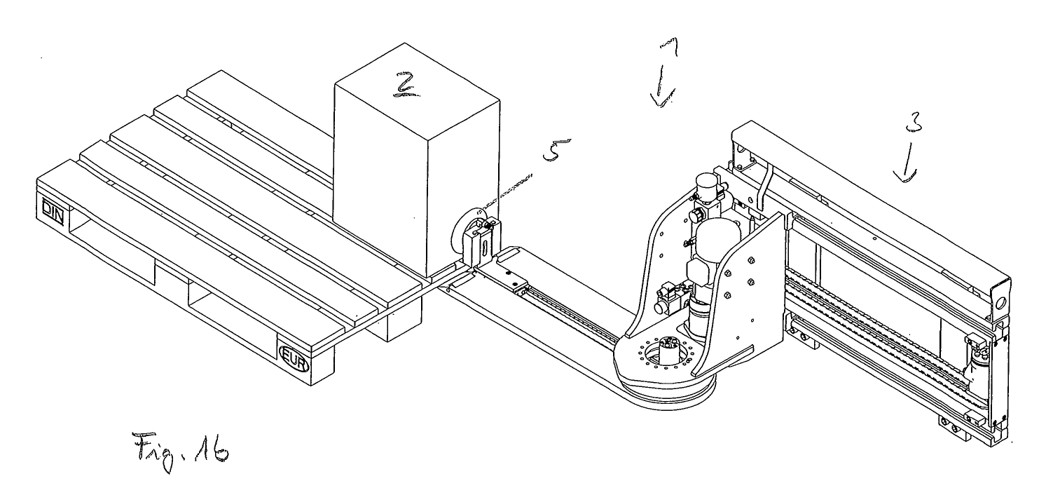

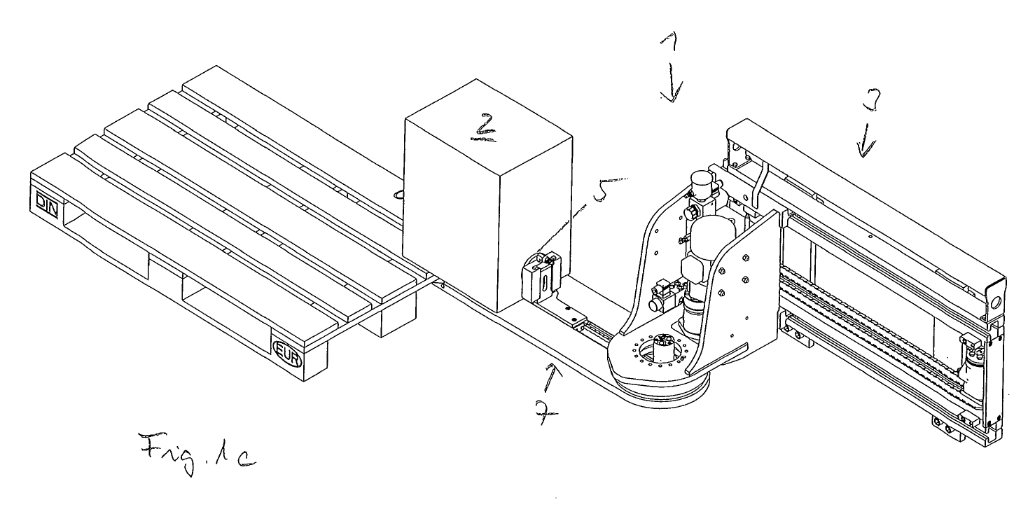

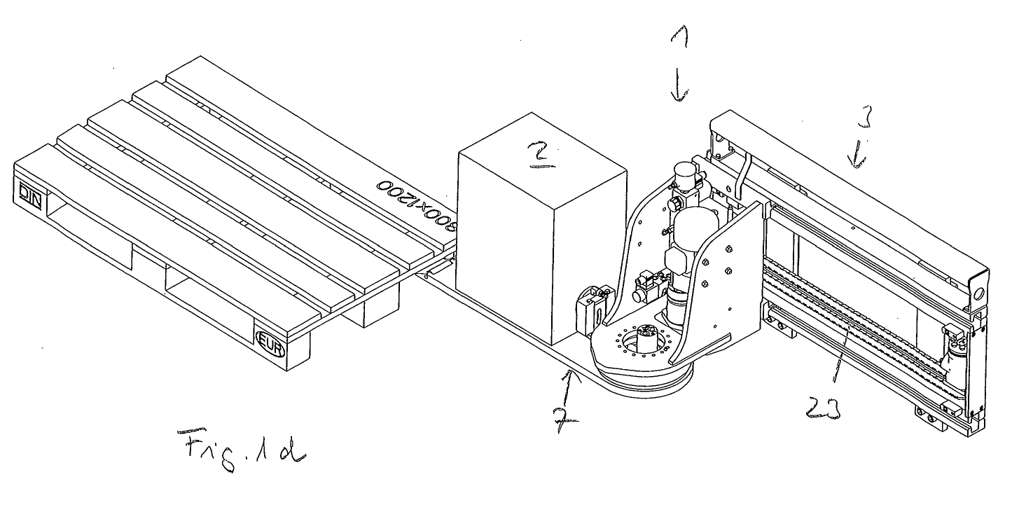

FIG. 1a shows an apparatus 1 for transport of a transport item 2 for arranging at a lifting vehicle, not shown, especially at a transportation unit 3 of a fork lifter, especially of a commissioning package, especially with a load lower than about 50 kg, The apparatus comprises a means 4 for at least temporarily picking up the transport item 2 by a vacuum means 5 and/or a transportation belt 27, whereas the vacuum means 5 is to be attached to the transport item 2 essentially in the horizontal, and/or the transportation belt 27 at a lower edge of the transport item 2, whereas the vacuum means 5 and/or the transportation belt 27 is attached to an adjustable arm 7 with a pivot point 8, which allows a handling of the transport item 2 with the vacuum means 5 and/or the transportation belt 27, especially a pivoting, especially in a defined pivoting angle 9, especially about +/−90°, in the horizontal 6, and/or allows dropping of the transport item 2, especially in the horizontal.

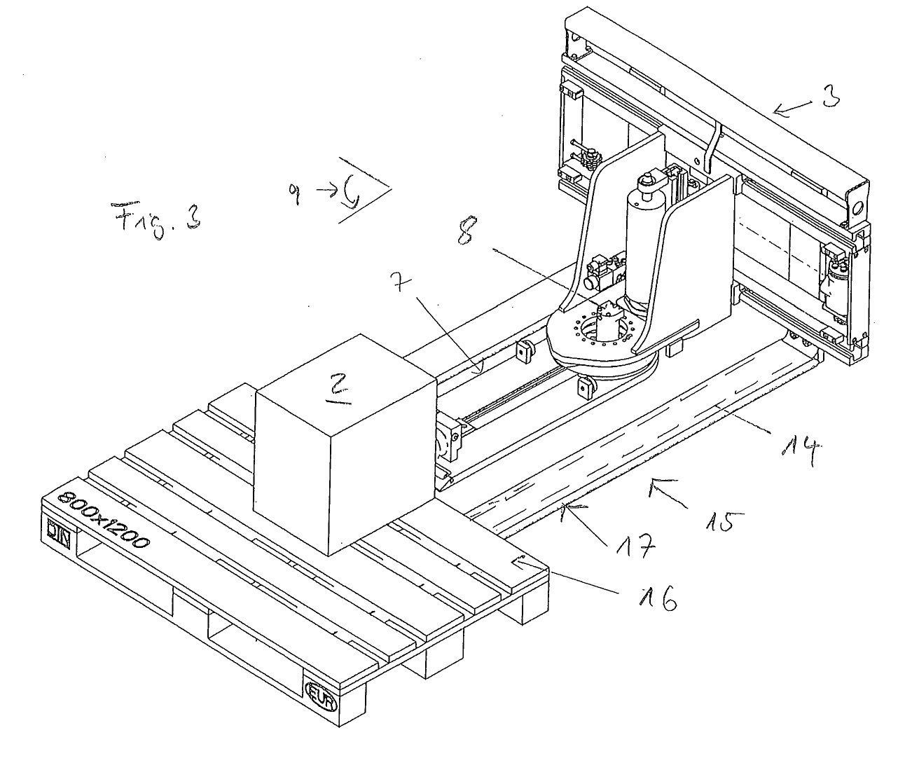

As an optional feature or alternative to the vacuum means 5 transport belts 27 are sketched arranged on the pivot arm 7. On a pivot arm 7 a movable vacuum suction cup is arranged, which can be transported laterally to a transport item 2, for example a box. By vacuum and/or transportation belt 27 the load can be pulled back nearly to the pivot point 8 and pivoted by about 90° in the horizontal. Then a pushing in a driving direction of the lifting vehicle is practised, for example onto a pallet 16, that is carried by the forks, as shown in FIG. 3.

The fork lifter drives for example parallel to the shelf to a respective transport storage position. There it turns the apparatus by 90° into the shelf. After the driving of the pushing unit and lowering down of the device on the load the vacuum unit is activated. Hold by the vacuum, the load can be lifted and be transported out of shelf by moving of the movable unit until they are situated in the middle in relation to the turning device. Alternatively or complementary on the pivot arm one or more transportation belts can be provided for transportation and or unloading of the transport unit, whereby this can be provided alternatively to the vacuum unit or complementary to this. Thereafter the load can be turned by about 90° and then unloaded for example on a pallet, which is situated in a corridor, or on a wagon. After the unloading and deactivation of the vacuum the device can be loaded and adapted on the next commissioning procedure.

FIG. 1b shows an apparatus 1 for transport at a transport unit 3, where the vacuum unit 5 is arranged at the transport item 2.

FIG. 1c shows an apparatus 1 for transport at a transport unit 3, where the vacuum unit 5 is arranged at the transport item 2 and a pulling back of the transport item 2 on the pivot arm 7 is taking place partially.

FIG. 1d shows an apparatus 1 for transport at a transport unit 3, where the vacuum unit 5 is arranged at the transport item 2 and a pulling back of the transport item 2 on the pivot arm 7 is taking place totally.

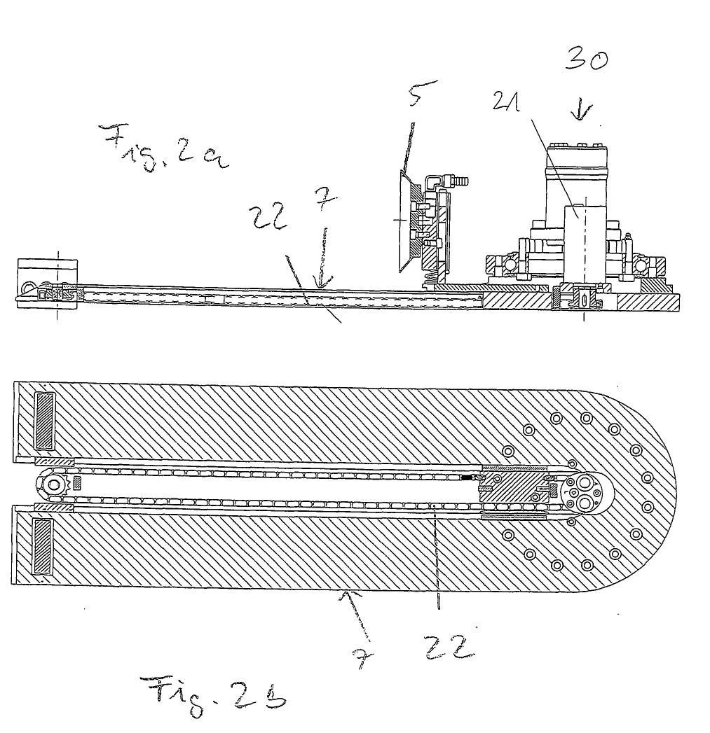

FIG. 2a shows an apparatus 1 for transport in a side sectional view. A vacuum unit 5 is driven for and back by a chain drive 22, which is situated in the pivot arm 7 and is driven by an oil motor 21.

FIG. 2b shows an apparatus 1 for transporting, according FIG. 2a in plan view.

FIG. 3 shows an apparatus 1 for transport at a transport unit 3 with a means 15 for the transport of a pallet 16, whereas especially two or more forks 17 are provided, on which the pallet 16 is to be carried with and to be loaded with the transport item 2 and/or unloaded, especially comprising fork stubs 18 with adaptable fork shoes 19 and/or forks, which are provided with transportation belts 14 for loading and/or unloading of the pallet. The transport item 2, that is transported out of a exemplified side shelf, which is not shown, with a pivot arm 7 on a pallet 16.

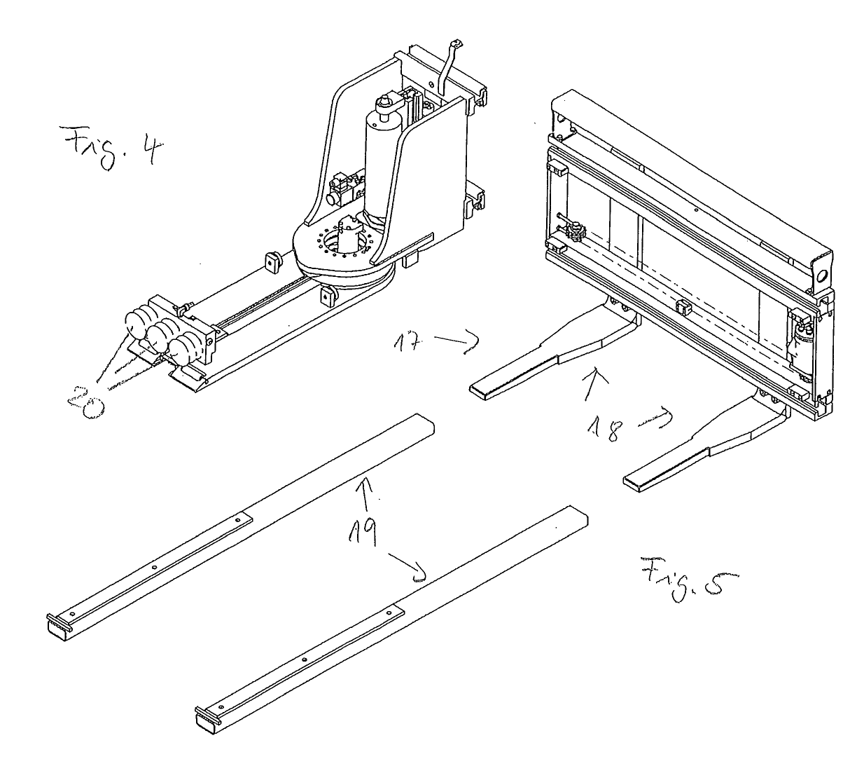

FIG. 4 shows a means 4 for at least temporarily picking up of a transport item of an apparatus for transporting at a transport device for a fork lifter with three, vacuum cups 20 positioned beneath each other.

FIG. 5 shows an apparatus 1 with a fork stub 18 and adaptable fork shoes 19, which can work as a fork 17.

### LIST OF REFERENCE NUMERALS

1 apparatus for transport
2 transport item
3 transport unit
4 means for at least temporarily picking up
5 vacuum means
6 horizontal
7 pivot arm
8 pivot point
9 pivot angle
12 driving means
14 transportation belt
15 means for transport
16 pallet
17 fork
18 fork stub
19 fork shoe
20 vacuum cup
21 oil motor for vacuum means
22 chain drive
23 chain drive
24 oil motor
25 vacuum pump
27 transportation belt
28 lower edge
29 section between pivot arm and driving means
30 oil motor

1. Apparatus (1) for transport of a transport item (2) for arranging at a lifting vehicle, especially at a transport unit (3) of a fork lifter, especially of a commissioning package, especially with a load lower than about 50 kg, comprising a means (4) for at least temporarily picking up of the transport item (2) by a vacuum means (5) and a transportation belt (27), whereas the vacuum means (5) is to be attached to the transport item (2) essentially in the horizontal, and the transportation belt (27) at a lower edge of the transport item (2),
whereas the vacuum means (5) and/sc the transportation belt (27) are attached to a pivot arm (7) with a pivot point (8), which allows a handling of the transport item (2) with the vacuum means (5) and the transportation belt (27), especially a pivoting, especially in a defined pivoting angle (9), especially about +/−90°, in the horizontal (6), and/or allows dropping of the transport item (2), especially in the horizontal (6).

2. Apparatus according to claim 1, wherein the pivot arm (7) is provided to be adjustable longitudinally with a means for pivoting, especially with an oil motor (30) and/or a means for adjusting the length, driven especially by a hydraulic means and or means, that is driven by an oil motor.

3. Apparatus according to claim 1, wherein the vacuum means (5) is formed to be adjustable longitudinally in relation to the adjustable arm (7), especially up or low, especially by a chain drive (22), which is driven specially by an oil motor (21).

4. Apparatus according to claim 1, wherein the pivot arm (7) with a driving means (12), especially in the surrounding of the pivot point (8), is arranged to be driven laterally, especially by a chain drive (23), especially driven by an oil motor (24), especially arranged at a transport unit (3) of a lifting vehicle.

5. Apparatus according to claim 1, wherein the vacuum means (5) is provided to be adjustable with a second pivoting means for a direction down to a direction horizontal (6), whereas for the transport of the transport item (2) the vacuum means (5) is pivoted hereby into horizontal (6).

6. Apparatus according to claim 1, wherein the vacuum means (5) is movably arranged on the pivot arm (7), so that the transport item (2) can be picked up by the vacuum means (5) and to be accommodated rested at least temporarily on the pivot arm (7) and/or to be deposable from it.

7. Apparatus according to claim 1, wherein a means (15) for transport of a pallet (16) is provided, whereas especially two or more forks (17) are provided, on which the pallet (16) is to be transported and to be loaded with the transport item (2) and/or unloaded, especially comprising fork stubs (18) with attachable fork shoes (19) and or forks, that are provided with transportation belts (14) for loading and/or unloading of pallets.

8. Apparatus according to claim 1, wherein the vacuum means (5) is provided with vacuum by a vacuum pump (25), especially arranged in a section (29) between pivot arm (7) and driving means (12), whereas the vacuum pump (25) is especially driven by an electromotor and/or oil motor, and/or by a combination means comprising a hydraulic cylinder and/or air cylinder and or preloading valve, especially driven by an oil motor, so that especially first a vacuum is gained by the hydraulic cylinder with the air cylinder and then a driving movement on the pivot arm (7) is executable.

9. Apparatus according to claim 1, wherein the vacuum means (5) comprises one or more vacuum cups (20), which are especially arranged beneath each other.

10. Method for use of an apparatus (1) for transport of a transport item (2), especially of a commissioning package, especially with a load lower than about 50 kg, whereby the apparatus is suitable for attachment to a transport unit (3) at a lifting vehicle, especially at a fork lifter, whereas by a means (4) for at least temporarily picking up a transport item (2) is picked up by a vacuum means (5) and a transportation belt (27), whereas the vacuum means (5) is attached to the transport item (2) essentially in the horizontal, and the transportation belt (27) is attached at a lower edge of the transport item (2), whereas the vacuum means (5) and the transportation belt (27) are attached to an adjustable arm (7) with a pivot point (8), so that the transport item (2) is pivoted by the vacuum means (5) and the transportation belt (27) especially in the horizontal (6), in a defined pivoting angle (9), especially about +/−90°, and/or on the pivot arm (7) by a method of the vacuum means (5) and der transportation belt (27) uploaded and unloaded.

11. Apparatus according to claim 2, wherein the vacuum means (5) is formed to be adjustable longitudinally in relation to the adjustable arm (7), especially up or low, especially by a chain drive (22), which is driven specially by an oil motor (21).

12. Apparatus according to claim 3, wherein the pivot arm (7) with a driving means (12), especially in the surrounding of the pivot point (8), is arranged to be driven laterally, especially by a chain drive (23), especially driven by an oil motor (24), especially arranged at a transport unit (3) of a lifting vehicle.

13. Apparatus according to claim 12, wherein the vacuum means (5) is moveably arranged on the pivot arm (7), so that the transport item (2) can be picked up by the vacuum means (5) and to be accommodated rested at least temporarily on the pivot arm (7) and/or to be deposable from it.

14. Apparatus according to claim 13, wherein a means (15) for transport of a pallet (16) is provided, whereas especially two or more forks (17) are provided, on which the pallet (16) is to be transported and to be loaded with the transport item (2) and/or unloaded, especially comprising fork stubs (18) with attachable fork shoes (19) and or forks, that are provided with transportation belts (14) for loading and/or unloading of pallets.

15. Apparatus according to claim 13, wherein the vacuum means (5) is provided with vacuum by a vacuum pump (25), especially arranged in a section (29) between pivot arm (7) and driving means (12), whereas the vacuum pump (25) is especially driven by an electromotor and/or oil motor, and/or by a combination means comprising a hydraulic cylinder and/or air cylinder and or preloading valve, especially driven by an oil motor, so that especially first a vacuum is gained by the hydraulic cylinder with the air cylinder and then a driving movement on the pivot arm (7) is executable.
